(19) United States
(12) Patent Application Publication
(10) Pub. No.: US 2022/0386597 A1
(43) Pub. Date: Dec. 8, 2022

(54) SANITARY WARE

(71) Applicant: TOTO LTD., KITAKYUSHU-SHI (JP)

(72) Inventors: Tomoki KOBAYASHI, KITAKYUSHU-SHI (JP); Katsuhiro KAWAKAMI, KITAKYUSHU-SHI (JP); Aki IWASAWA, KITAKYUSHU-SHI (JP); Hideaki YAMAGUCHI, KITAKYUSHU-SHI (JP); Kyoko UEKI, KITAKYUSHU-SHI (JP); Hiromasa TOKUDOME, KITAKYUSHU-SHI (JP); Takuma KAWASAKI, KITAKYUSHU-SHI (JP)

(21) Appl. No.: 17/828,217

(22) Filed: May 31, 2022

(30) Foreign Application Priority Data
May 31, 2021 (JP) 2021-091695

(51) Int. Cl. A01N 25/34; A01N 59/00; C04B 41/50

(52) U.S. Cl. CPC A01N 25/34; A01N 59/00; C04B 41/50; C04B 2111/00025

(57) ABSTRACT

Disclosed is a sanitary ware having not only a practical antivirus property but also a property which allows a pollution to be difficultly attached to, and to be easily removed from the sanitary ware. A sanitary ware comprising a pottery substrate and a glaze layer formed on a surface of the pottery substrate, wherein the glaze layer contains a metal element as an antivirus agent, and the metal element is present in a state of a spinodal phase separation in at least a surface region of the glaze layer, has a practical antivirus property as well as a property which allows a pollution to be difficultly attached to, and to be easily removed from, the sanitary ware.

### TECHNICAL FIELD

The present invention relates to a sanitary ware, more specifically, to a sanitary ware having not only an antivirus property but also fouling resistance and decontamination performance.

### BACKGROUND ART

On the outermost surface of a sanitary ware is formed a glaze layer in order to ensure a sanitary surface and to ensure an appearance designability. For the improvement of the sanitary ware in a sanitary aspect, a technology of adding an antibacterial agent to the glaze layer has been proposed. For example, CN 111393188 A (Patent Literature 1) discloses a sanitary ware having a base glaze layer and a top glaze layer that contains a nano-size silver-based antibacterial agent.

Furthermore, an example in which an antivirus property is imparted to a composite oxide has been reported; WO 2020/017493 A1 (Patent Literature 2) indicates that a composite oxide ceramic containing a rare earth element and a specific metal element other than the rare earth element has both a water-repellent property as well as an antibacterial and antivirus properties. Specifically, PTL 2 discloses that a calcinated powder (500° C.) of a composite oxide ceramic (LMO) containing lanthanum (La) and molybdenum (Mo) exhibits a higher activity against bacteriophages Qβ and Φ6 than a single metal oxide (a La₂O₃ particle) (see, paragraphs 0067, 0069-0071; and FIG. 8).

Patent Literature 2, discloses that a calcinated powder (500° C., 400° C., or 550° C.) of a composite oxide ceramic containing lanthanum (La), and molybdenum (Mo) and/or tungsten (W) (LMO, LWO, LCMO (at least one La in LMO is (are) substituted by cerium (Ce), and LMWO (at least one Mo in LMO is (are) substituted by W)) exhibits an activity against bacteriophages Qβ and Φ6 (see, FIGS. 11, 14 to 17, and 20), although any comparison of said calcinated powder with a single metal oxide is not confirmed in the PTL 2.

Annual Report of Cosmetology, Vol. 28, 2020, p. 43-52 (Non-Patent Literature 1), which is written by the inventor of Patent Literature 2, also discloses the contents similar to those of Patent Literature 2 is disclosed. Namely, NPL 1 discloses that against bacteriophages Qβ and Φ6, CeO₂ hardly exhibits an activity, but La₂O₃ exhibits a certain activity; on the other hand, the anti-Qβ and anti-Φ6 activities of La₂O₃ are lower than those of LMO (see, page 47, right column, second paragraph; and FIG. 7).

In addition, an example in which an antivirus property is imparted to a liquid composition is reported; JP 2020-111546 A (Patent Literature 3) teaches an antivirus composition containing a rare earth salt, a zinc salt, and water. Specifically, PTL 3 discloses that an aqueous solution containing lanthanum chloride, cerium chloride, neodymium chloride or ytterbium acetate; and zinc gluconate has a lower virus infectivity titer (Log(PFU)), namely, has a higher antivirus property than the same aqueous solution except that it is devoid of either the rare earth salt or the zinc salt. Patent Literature 3 discloses that the antivirus composition is applied to a fiber, and suggests that the composition is applied to a coating material such as a paint. However, PTL 3 does not disclose that the antivirus composition is applied to a ceramic material, let alone a glaze material.

Some of the literatures described above discloses that a combination of a metal element (or a salt thereof) and a metal element other than the former (or a salt thereof) has an antivirus property. However, none of these literatures has reported that a metal element alone has an antivirus property sufficient for practical use, or has considered imparting an antivirus property to a glaze layer of a sanitary ware. Furthermore, because of a novel coronavirus pandemic in recent years, needs for a sanitary ware with a top glaze layer having a practical antivirus property have been increasing. In addition, when an additive is added to a glaze, in general, the surface of a sanitary ware becomes rough, which might be undesirable in terms of an anti-fouling property or of designability.

### CITATION LIST

### Patent Literatures

[PTL 1] CN 111393188 A
[PTL 2] WO 2020/017493 A1
[PTL 3] JP 2020-111546 A

### Non Patent Literatures

[NPL 1] Annual Report of Cosmetology, Vol. 28, 2020, p. 43-52

### SUMMARY OF INVENTION

### Technical Problem

The inventors of the present application confirmed by the experiments that when a metal element is present in a specific state in a glaze layer of a sanitary ware, the metal element expresses by itself a practical antivirus property, and realizes a surface property that is excellent in fouling-resistance and in decontamination performance (namely, a surface property which allows a pollution or fouling to be difficultly attached to, and to be easily removed from the sanitary ware). The present invention is based on the findings above.

Accordingly, an object of the present invention is to provide a sanitary ware with a glaze layer having not only a practical antivirus property but also a property which allows a pollution to be attached with difficulty to, and to be removed with ease from the sanitary ware.

### Solution to Problem

A sanitary ware according to the present invention includes

a pottery substrate and a glaze layer formed on a surface of the pottery substrate, characterized in that

the glaze layer contains a metal element as an antivirus agent, and

the metal element is present in a state of a spinodal phase separation in at least a surface region of the glaze layer.

### Effects of Invention

According to the present invention, a sanitary ware with a glaze layer having a practical antivirus property as well as a property which allows a pollution to be difficultly attached to and to be easily removed from the sanitary ware.

### BRIEF DESCRIPTION OF DRAWINGS

FIG. 1A is a schematic diagram of a sanitary ware according to the present invention;

FIG. 1B is a schematic diagram of one embodiment of the sanitary ware according to the present invention;

FIG. 2 is the XRD pattern of a glaze layer of a sanitary ware according to the present invention;

FIG. 3A is the surface SEM image of a glaze layer of a sanitary ware according to the present invention, showing that lanthanum (La) is present in a state of a spinodal phase separation on the surface of the glaze layer;

FIG. 3B is the cross-sectional SEM image of a glaze layer of a sanitary ware according to the present invention, showing that lanthanum (La) is present in a state of a spinodal phase separation in the proximity of a surface of the glaze layer;

FIG. 4A is the surface SEM image of a glaze layer of a sanitary ware according to the present invention, showing that neodymium (Nd) is present in a state of a spinodal phase separation on the surface of the glaze layer;

FIG. 4B is the cross-sectional SEM image of a glaze layer of a sanitary ware according to the present invention, showing that neodymium (Nd) is present in a state of a spinodal phase separation in the proximity of a surface of the glaze layer;

FIG. 5A is the surface SEM image of a glaze layer of a sanitary ware according to the present invention, showing that praseodymium (Pr) is present in a state of a spinodal phase separation on the surface of the glaze layer;

FIG. 5B is the cross-sectional SEM image of a glaze layer of a sanitary ware according to the present invention, showing that praseodymium (Pr) is present in a state of a spinodal phase separation in the proximity of a surface of the glaze layer;

FIG. 6A is the surface SEM image of a glaze layer of a sanitary ware according to the present invention, showing that samarium (Sm) is present in a state of a spinodal phase separation on the surface of the glaze layer;

FIG. 6B is the cross-sectional SEM image of a glaze layer of a sanitary ware according to the present invention, showing that samarium (Sm) is present in a state of a spinodal phase separation in the proximity of a surface of the glaze layer;

FIG. 7A is the surface SEM image of a glaze layer of a sanitary ware according to the present invention, showing that gadolinium (Gd) is present in a state of a spinodal phase separation on the surface of the glaze layer;

FIG. 7B is the cross-sectional SEM image of a glaze layer of a sanitary ware according to the present invention, showing that gadolinium (Gd) is present in a state of a spinodal phase separation in the proximity of a surface of the glaze layer;

FIG. 8A is the surface SEM image of a glaze layer of a sanitary ware according to the present invention, showing that dysprosium (Dy) is present in a state of a spinodal phase separation on the surface of the glaze layer;

FIG. 8B is the cross-sectional SEM image of a glaze layer of a sanitary ware according to the present invention, showing that dysprosium (Dy) is present in a state of a spinodal phase separation in the proximity of a surface of the glaze layer;

FIG. 9A is the surface SEM image of a glaze layer of a sanitary ware according to the present invention, showing that holmium (Ho) is present in a state of a spinodal phase separation on the surface of the glaze layer;

FIG. 9B is the cross-sectional SEM image of a glaze layer of a sanitary ware according to the present invention, showing that holmium (Ho) is present in a state of a spinodal phase separation in the proximity of a surface of the glaze layer;

FIG. 10A is the surface SEM image of a glaze layer of a sanitary ware according to the present invention, showing that erbium (Er) is present in a state of a spinodal phase separation on the surface of the glaze layer;

FIG. 10B is the cross-sectional SEM image of a glaze layer of a sanitary ware according to the present invention, showing that erbium (Er) is present in a state of a spinodal phase separation in the proximity of a surface of the glaze layer;

FIG. 11A is the surface SEM image of a glaze layer of a sanitary ware according to the present invention, showing that ytterbium (Yb) is present in a state of a spinodal phase separation on the surface of the glaze layer;

FIG. 11B is the cross-sectional SEM image of a glaze layer of a sanitary ware according to the present invention, showing that ytterbium (Yb) is present in a state of a spinodal phase separation in the proximity of a surface of the glaze layer;

FIG. 12A is the surface SEM image of a glaze layer of a sanitary ware according to the present invention, showing that yttrium (Y) is present in a state of a spinodal phase separation on the surface of the glaze layer;

FIG. 12B is the cross-sectional TEM image of a glaze layer of a sanitary ware according to the present invention, showing that yttrium (Y) is present in a state of a spinodal phase separation in the proximity of a surface of the glaze layer;

FIG. 13A illustrates the relationship between the amount of lanthanum in terms of lanthanum oxide and the amount of lanthanum eluted to the surface of the glaze layer;

FIG. 13B illustrates the relationship between the amount of lanthanum eluted and the antivirus activity value;

FIG. 14A illustrates the relationship between the amount of lanthanum (% by weight) in terms of lanthanum oxide and the abundance (existing amount) (% by mass) of lanthanum atom measured by XRF;

FIG. 14B illustrates the relationship between the abundance (% by mass) of lanthanum atom measured by XRF and the antivirus activity value;

FIG. 15A is the cross-sectional SEM image showing the existing state of lanthanum in a glaze layer, when a glaze containing 10% by weight of lanthanum oxide as a raw material of an antivirus agent is fired under the firing condition 1 (at 1,200° C. for a short period of time);

FIG. 15B is the cross-sectional SEM image showing the existing state of lanthanum in a glaze layer, when a glaze containing 10% by weight of lanthanum oxide as a raw material of an antivirus agent is fired under the firing condition 2 (at 1,200° C. for an intermediate period of time); and

FIG. 15C is the cross-sectional SEM image showing the existing state of lanthanum in a glaze layer, when a glaze containing 10% by weight of lanthanum oxide as a raw material of an antivirus agent is fired under the firing condition 3 (at 1,200° C. for a long period of time).

### DESCRIPTION OF EMBODIMENTS OF INVENTION

### Definition

In the present invention, the term “sanitary ware” means a pottery product that is used around a toilet and a wash room, and specifically means a closet bowl, a urinal, a perforate plate, a toilet tank, a washbowl on a washstand, a hand washer, etc. The term “pottery” means, among ceramics including porcelain, one whose substrate has a hardly water-absorbing property, a surface of said substrate being glazed.

In the present invention, the fact that a metal element “alone” expresses (“by itself”) a practical antivirus property means that a metal element per se expresses a practical antivirus property, which is contrary to the disclosure in Patent Literature 2 that the composite oxide containing lanthanum and other metals (Mo and W) expresses the practical antivirus property, and to the disclosure in Patent Literature 3 that the liquid composition containing a rare earth salt and other metal salt (zinc salt) expresses the practical antivirus property.

### Sanitary Ware

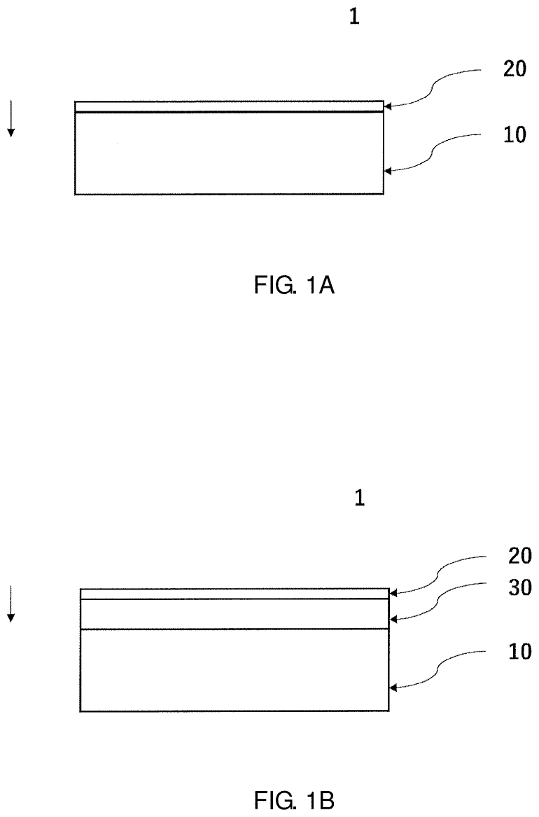

The sanitary ware according to the present invention has, as illustrated in FIG. 1A, at least a pottery substrate 10 and a glaze layer 20 containing an antivirus agent, which is formed on a surface of the pottery substrate.

The sanitary ware 1 according to the present invention may further have one, or two or more other glaze layers between the pottery substrate 10 and the glaze layer 20 containing the antivirus agent. For example, according to one embodiment of the present invention, as illustrated in FIG. 1B, the sanitary ware 1 has the pottery substrate 10, a glaze layer 30 formed on the surface of the pottery substrate 10, and the glaze layer 20 containing the antivirus agent, which is formed on the surface of the glaze layer 30. In the present invention, the glaze layer 30 is referred to as a base glaze layer, and the glaze layer 20 is referred to as an antivirus glaze layer. The base glaze layer 30 is not particularly restricted; so, this may be a usual glaze layer formed on a pottery substrate.

In the present invention, the term “surface” of the glaze layer 20 means the surface with the depth of 0 μm in the depth direction as illustrated by the arrow in FIG. 1A or FIG. 1B. The expression “in the proximity of” the glaze layer 20 means a region ranging from the surface of the glaze layer 20 to a location with the depth of, for example, about 1/10 or 1/15 of the thickness of the glaze layer 20 in the depth direction as illustrated by the arrow in FIG. 1A or FIG. 1B.

### Pottery Substrate

The pottery substrate 10 is not particularly restricted; so, this may be a heretofore known pottery substrate. Namely, the pottery substrate 10 may be one of those obtained as appropriate by molding a slurry for a sanitary ware substrate that is prepared from raw materials such as silica sand, feldspar, clay and others.

### Glaze Layer

In the present invention, the glaze layer 20 contains, as ingredients thereof, a metal element as an antivirus agent, and glaze materials described later. The metal element, which is the antivirus agent, is present in a state of a spinodal phase separation at least on the surface of the glaze layer 20.

### Existing State of Antivirus Agent in Glaze Layer 20

In the present invention, the antivirus agent is present in an amorphous (non-crystalline) state at least on the surface of the glaze layer 20. Specifically, the antivirus agent is present in a vitrified state at least on the surface of the glaze layer 20. More specifically, the antivirus agent is present in the state of a spinodal phase separation in the glaze layer 20. In the present invention, the term “spinodal phase separation” means, in general, a state in which precipitation of particles due to their crystallization is suppressed in the glaze layer, thereby resulting in expressing the effects that stable elution of the antivirus agent to the surface of the glaze layer becomes easier, and also, even when the antivirus agent is present on the surface of the glaze layer, the impact on the surface property of the glaze layer is suppressed.

Due to the presence of the antivirus agent in the state of the spinodal phase separation at least on the surface of the glaze layer 20, the antivirus agent can be eluted in a chemically-stable state, namely, in an ionized state, from the surface of the glaze layer 20, so that a virus that is attached to the surface of the glaze layer 20 can be efficiently deactivated. Accordingly, the glaze layer 20 can express an excellent antivirus property. Also, due to the presence of the antivirus agent in the state of the spinodal phase separation at least on the surface of the glaze layer 20, phases in which the antivirus agents are abundantly present can exist homogenously on the surface, and consequently, the antivirus agent can be eluted stably to the surface, thereby imparting a high antivirus property to the surface.

In the present invention, it is preferable that the antivirus agent is present in the state of the spinodal phase separation in a region ranging from the surface of the glaze layer 20 to a location with the depth of 10 nm inside the glaze layer in the depth direction as illustrated by the arrow in FIG. 1A or FIG. 1B. Due to the presence of the antivirus agent in the state of the spinodal phase separation in this region, elution of the antivirus agent is facilitated, so that the glaze layer 20 can express a more excellent antivirus property. In addition, the impact on the surface property of the glaze layer can be more suppressed.

The presence of the antivirus agent in the state of the spinodal phase separation at least on the surface of the glaze layer 20 can be realized, as described later, by integrally firing the pottery substrate 10 and a glaze for forming the glaze layer 20 once, followed by cooling the fired product. Specifically, by integrally firing the pottery substrate 10 and the glaze for forming the glaze layer 20 once, followed by cooling the fired product, a phase separation of a glass can be induced. The phase separation of a glass is a phenomenon that a single phase glass is separated into a plurality of phases. When a glass composed of a plurality of ingredients is present in a homogeneous liquid phase (glass melt), as a temperature is lowered, there exists a region whose free energy is lower when the region is in a mixed state of two phases than when the region is in a state of a single phase. The glass melt in this region undergoes phase separation because the glass melt is thermodynamically more stable when separated into two phases.

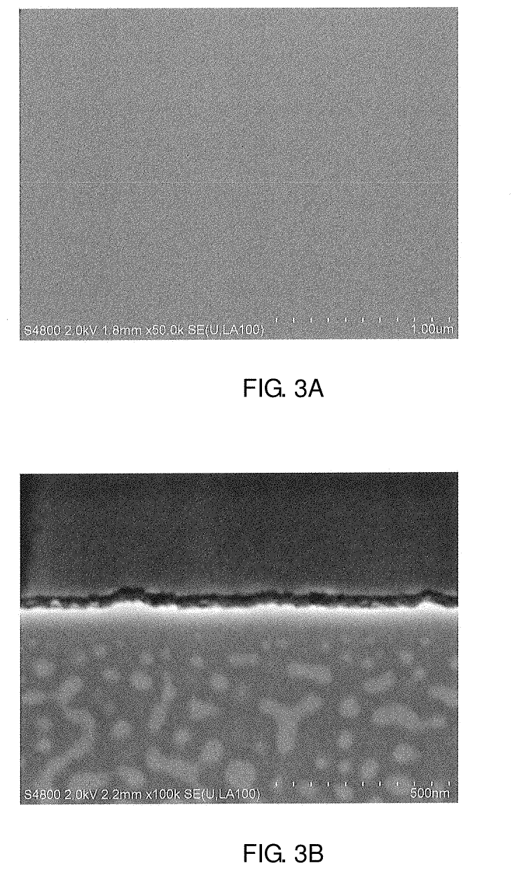

In the present invention, the glaze composed of a plurality of ingredients, which are to be contained in the glaze layer 20, including a metal compound which is a raw material of an antivirus agent (a metal element), SiO₂ described later, and a metal oxide other than the raw material compound for the antivirus agent is fired to obtain a homogeneous (single) glass liquid phase (a glass melt). In a phase equilibrium diagram of a glass, the glass melt is placed in a metastable immiscibility region as it is cooled to the temperature of equal to or lower than the liquid phase line. In the metastable immiscibility region, there exist (i) a binodal region in which the glass melt undergoes phase separation by the nucleation-growth mechanism in which a nucleus is generated and developed, and (ii) a spinodal region in which the glass melt becomes thermodynamically unstable thereby undergoing phase separation without nucleation (spinodal decomposition mechanism). In the binodal region, one of the two phases formed by the phase separation exists in such a condition that it is dispersed in the shape of a spherical particle without intertangling with the other; while, in the spinodal region, one of the two phases formed by the phase separation exists in such a condition that it is dispersed in the shape of a non-spherical particle with intertangling to a high extent with the other. Theoretically, it is considered that, in the glaze layer, the antivirus agent can be both in the state of the binodal phase separation and in the state of the spinodal phase separation; but, in the present invention, by integrally firing the pottery substrate 10 and the glaze for forming the glaze layer 20 once and thereafter cooling the fired product, although the details of the mechanism are not clear, the antivirus agents can be made to be present abundantly in the proximity of the surface of the glaze layer, and at the same time, in the proximity of the surface of the glaze layer, the proportion of the antivirus agents that are present in the state of the spinodal phase separation to the antivirus agents that are present in the state of the binodal phase separation can be increased. This is confirmed by the experiments described later; for example, as can be shown in FIGS. 3 to 12, in the proximity of the surface of the glaze layer 20, the antivirus agents exist abundantly and in the state of the spinodal phase separation.

It is considered that the embodiment in which a specific lanthanoid is present in the state of the spinodal phase separation in the proximity of the surface of the glaze layer includes, for example, a state in which a phase abundant in the antivirus agents is intertangled with a phase not abundant in the antivirus agents (—Si—O- structure); and a state in which a portion abundant in the antivirus agents is more intertangled with a portion not abundant in the antivirus agents (namely, a state in which said portions are present more homogeneously and at higher resolution). More generically, the embodiment includes a state in which a portion abundant in the antivirus agents in a glass matrix structure on the surface of the glaze layer forms, together with other portion(s), a intertangled structure as a whole. It is considered that due to the presence of the antivirus agents in the states like the above in the proximity of the surface of the glaze layer, the macroscopically homogeneous elution of the antivirus agents from the surface of the glaze layer becomes possible or facilitated, and as a result, a high antivirus property can be expressed.

It goes without saying that the present invention encompasses any embodiment in which the region in which the antivirus agents are present in the state of the spinodal phase separation exists in the proximity of the surface of the glaze layer 20, as long as the effects of the present invention can be achieved by the embodiment. It is however noted that any embodiment in which, due to, for example, an inevitable reason in a process of producing the glaze layer 20, the proportion of the region where the antivirus agents are in the state of the binodal phase separation to the region where the antivirus agents are in the state of the spinodal phase separation is low is not excluded from the scope of the present invention, as long as the embodiment does not inhibit the effects of the present invention.

### Confirmation of the Presence State of Antivirus Agent in Glaze Layer 20 XRD Measurement

The fact that the antivirus agents are present in an amorphous (non-crystalline) state, specifically, in a vitrified state, at least on the surface of the glaze layer 20 can be confirmed by XRD measurement of the surface of the glaze layer 20. For example, the measurement may be carried out by using a XRD instrument (“X′Pert PRO”, manufactured by PANalytical Inc.) under the following conditions. When any peak is not found by the measurement, it is confirmed that the antivirus agents are not in a crystal state, namely are in the amorphous (non-crystalline) state, preferably are in the vitrified state.

### <XRD Measurement Conditions>

Measurement range: 3° to 60°
Scanning rate: 4°/min
Applied voltage: 45 V, applied current: 40 mA

### SEM Measurement and TEM Measurement

The fact that the antivirus agents are present in the state of the spinodal phase separation at least on the surface of the glaze layer 20 can be confirmed by the SEM observation or the TEM observation of the region including the surface of the glaze layer 20. For example, the SEM observation can be carried out by using the instrument S4800 (manufactured by Hitachi High-Tech Corp.) under the conditions: magnification of 50,000×, the applied voltage of 2.0 kV, and the applied current of 20 mA (2.0 mm×50.0 k, SE (U, LA100)). The TEM observation can be carried out by using the instrument H-9500 (manufactured by Hitachi High-Tech Corp.) under the conditions: magnification of 100,000×and the applied voltage of 200 kV.

### Antivirus Agent

In the present invention, the antivirus agent is preferably a rare earth element, namely, lanthanoid, or scandium (Sc) or yttrium (Y).

The lanthanoid is preferably at least one lanthanoidselected from the group consisting of 12 elements, i.e., lanthanum (La), praseodymium (Pr), neodymium (Nd), samarium (Sm), gadolinium (Gd), terbium (Tb), dysprosium (Dy), holmium (Ho), erbium (Er), thulium (Tm), ytterbium (Yb), and lutetium (Lu). In other words, the antivirus agent is preferably lanthanoid except for cerium (Ce), europium (Eu), and promethium (Pm) (hereinafter, the 12 lanthanoids except for Ce, Eu and Pm are referred to as “specific lanthanoid”). According to the preferred embodiment of the present invention, the specific lanthanoid is at least one lanthanoid selected from the group consisting of La, Gd, Dy, and Yb.

The reason why Ce and Eu are excluded from the lanthanoids is because only these two atoms classified as the lanthanoids have two kinds of stable valencies. Namely, Ce atom stably has two kinds of valencies of +3 valency and +4 valency, and Eu atom stably has two kinds of valencies of +2 valency and +3 valency; and thus, these atoms supplies electrons to Si—O bond in the glaze layer 20, which has an impact on the Si—O bond, such as elongation of the Si—O bond. Namely, Ce and Eu have an impact on a vitrified structure of the glaze layer 20, thereby rendering the surface of the glaze layer 20 roughened. Because of this, the surface property described later cannot be realized; so, these atoms are improper as ingredients to be contained in the glaze layer 20. In other words, in order to impart the antivirus property to the glaze layer of the sanitary ware, it is preferable to use, as the antivirus agent, those are less influential to the Si—O bond.

In the present invention, the reason why Pm is excluded from the lanthanoids is because, among the lanthanoids, this atom does not exist stably; instead, this atom is radioactive so that the physical properties thereof are significantly different from those of other lanthanoids.

In the present invention, the antivirus property of the sanitary ware comprising the glaze layer 20 containing the metal element that is present in the state of the spinodal phase separation at least on the surface thereof can be shown, as an indicator thereof, by the antivirus activity value against the bacteriophage Qβ. The antivirus activity value can be obtained by the following test method, for example, based on ISO 21702.

### <Test Method of Antivirus Property>

A virus solution (0.4 mL) is dropped onto a test piece (a test piece of the sanitary ware comprising the glaze layer containing an antivirus agent), and onto a control (a test piece of the sanitary ware comprising the glaze layer not containing the antivirus agent); and then, the test pieces are covered with a film.
The test piece is statically left at 25° C. for 24 hours.
Next, the viruses on the test piece are washed off and recovered; then, the virus infectivity titer is measured.
By the following formula, the antivirus activity value is calculated to evaluate the antivirus property.

R=Uₜ-Aₜ

R: Antivirus activity value

Uₜ: Common logarithm of the virus infectivity titer (PFU/cm²) of the control, measured after the control has been statically left for 24 hours.

Aₜ: Common logarithm of the virus infectivity titer (PFU/cm²) of the test piece of the sanitary ware comprising the glaze layer containing the antivirus agent, measured after the test piece has been statically left for 24 hours.

In the present invention, the antivirus activity of the sanitary ware comprising the glaze layer containing the antivirus agent can be shown, as an indicator thereof, by the antivirus activity value (V) that is obtained in accordance with JIS R1756, under visible light B condition, in bright light. Specifically, the antivirus test is carried out by using the bacteriophage Qβ in accordance with JIS R1756, under visible light B condition. By using a 20 W of white mercury lamp (“Neoline” FL20S.W, manufactured by Toshiba Lighting & Technology Corp.) as a light source, a visible light having the wavelength of 380 nm or more is irradiated with the illuminance of 500 lux through the UV-cut filter (N-169, manufactured by Nitto Jushi Kogyo Co., Ltd.). The illuminance is measured by using an illuminance meter IM-5, manufactured by Topcon Corp. The antivirus activity value (V) in bright light under visible light-irradiation time of 4 hours is calculated by the following formula.

Antivirus activity value: V=Log₁₀(UV/TV)

TV: Bacteriophage infectivity titer (pfu) of the sanitary ware comprising the glaze layer containing the antivirus agent, measured after light irradiation.

UV: Bacteriophage infectivity titer (pfu) of a control, measured after light irradiation.

The sanitary ware comprising the glaze layer not containing the antivirus agent is used as the control.

In the present invention, the antivirus activity value of the glaze layer 20 containing the antivirus agent is preferably in the range of 2 to 6. The antivirus activity value of 2 or more satisfies the standard for the practical antivirus performance in the sanitary ware.

According to an embodiment of the present invention, provided is a sanitary ware capable of inactivating a virus attached to the surface of the glaze layer.

According to an embodiment of the present invention, provided is a method for expressing an antivirus property on a surface of a glaze layer containing a metal element as an antivirus agent, by allowing the metal element to be present in a state of a spinodal phase separation at least on the surface of the glaze layer, the glaze layer being formed on a surface of a pottery substrate to establish a sanitary ware.

In the present invention, in order to express the practical antivirus activity, the amount of a rare earth element eluted on the surface of the glaze layer 20 is preferably at least the value as described below:
Scandium (Sc):about 0.02 ppm,
Yttrium (Y):about 0.03 ppm,
Lanthanum (La):about 0.05 ppm,
Praseodymium (Pr):about 0.052 ppm,
Neodymium (Nd):about 0.052 ppm,
Samarium (Sm):about 0.054 ppm,
Gadolinium (Gd):about 0.056 ppm,
Terbium (Tb):about 0.057 ppm,
Dysprosium (Dy):about 0.057 ppm,
Holmium (Ho):about 0.058 ppm,
Erbium (Er):about 0.059 ppm,
Thulium (Tm):about 0.059 ppm,
Ytterbium (Yb):about 0.060 ppm,
Lutetium (Lu):about 0.061 ppm.

In a preferred embodiment of the present invention, the amount of the rare earth element eluted is about 1% to 2% of the content of the rare earth element contained in the region ranging from the surface of the glaze layer to a location with the depth of 10 nm inside the glaze layer in the direction from the surface of the glaze layer to the pottery substrate (in the direction as illustrated by the arrow in FIG. 1).

In a preferred embodiment of the present invention, the content of the antivirus agent in the glaze layer 20, when the total amount of the antivirus agent and other glaze materials described later of which the glaze layer is composed is 100% by weight, is preferably in the range of 1.0% by weight or more to 25% by weight or less, more preferably in the range of 5% by weight or more to 12% by weight or less, still more preferably in the range of 5% by weight or more to 9% by weight or less, in terms of the oxide of the antivirus agent. Here, it goes without saying that the amount of the oxide of the antivirus agent can be stoichiometrically converted to % by weight of the antivirus agent.

Preferred content of the antivirus agent (in terms of the oxide) in the glaze layer 20, for each rare earth element, is as follows:

Scandium (Sc): 0.4 to 8.0% by weight; the upper limit is preferably about 5.6% by weight, more preferably 4.4 to 4.8% by weight, still more preferably about 3.6% by weight; and the lower limit is preferably 2% by weight or more.

Yttrium (Y): 0.7 to 14.0% by weight; the upper limit is preferably about 9.8% by weight, more preferably 7.7 to 8.4% by weight, still more preferably about 6.3% by weight; and the lower limit is preferably 3.5% by weight or more.

Lanthanum (La): 1.0 to 20.0% by weight; the upper limit is preferably about 14% by weight, more preferably 11 to 12% by weight, still more preferably about 9%; and the lower limit is preferably 5% by weight or more.

Praseodymium (Pr): 1.0 to 20.0% by weight; the upper limit is preferably about 14% by weight, more preferably 11 to 12% by weight, still more preferably about 9%; and the lower limit is preferably 5% by weight or more.

Neodymium (Nd): 1.0 to 20.0% by weight; the upper limit is preferably about 14% by weight, more preferably 11 to 12% by weight, still more preferably about 9%; and the lower limit is preferably 5% by weight or more.

Samarium (Sm): 1.1 to 22.0% by weight; the upper limit is preferably about 15.4% by weight, more preferably 12.1 to 13.2% by weight, still more preferably about 9.9%; and the lower limit is preferably 5.5% by weight or more.

Gadolinium (Gd): 1.1 to 22.0% by weight; the upper limit is preferably about 15.4% by weight, more preferably 12.1 to 13.2% by weight, still more preferably about 9.9%; and the lower limit is preferably 5.5% by weight or more.

Terbium (Tb): 1.1 to 22.0% by weight; the upper limit is preferably about 15.4% by weight, more preferably 12.1 to 13.2% by weight, still more preferably about 9.9%; and the lower limit is preferably 5.5% by weight or more.

Dysprosium (Dy): 1.1 to 22.0% by weight; the upper limit is preferably about 15.4% by weight, more preferably 12.1 to 13.2% by weight, still more preferably about 9.9%; and the lower limit is preferably 5.5% by weight or more.

Holmium (Ho): 1.2 to 24.0% by weight; the upper limit is preferably about 16.8% by weight, more preferably 13.2 to 14.4% by weight, still more preferably about 10.8%; and the lower limit is preferably 6% by weight or more.

Erbium (Er): 1.2 to 24.0% by weight; the upper limit is preferably about 16.8% by weight, more preferably 13.2 to 14.4% by weight, still more preferably about 10.8%; and the lower limit is preferably 6% by weight or more.

Thulium (Tm): 1.2 to 24.0% by weight; the upper limit is preferably about 16.8% by weight, more preferably 13.2 to 14.4% by weight, still more preferably about 10.8%; and the lower limit is preferably 6% by weight or more.

Ytterbium (Yb): 1.2 to 24.0% by weight; the upper limit is preferably about 16.8% by weight, more preferably 13.2 to 14.4% by weight, still more preferably about 10.8%; and the lower limit is preferably 6% by weight or more.

Lutetium (Lu): 1.2 to 24.0% by weight; the upper limit is preferably about 16.8% by weight, more preferably 13.2 to 14.4% by weight, still more preferably about 10.8%; and the lower limit is preferably 6% by weight or more.

In case the glaze layer 20 contains the rare earth element in the amount described above range, it can express more excellent antivirus property.

In the present invention, the content of the antivirus agent in the glaze layer 20 can be also quantified by analyzing the glaze layer 20 with an X-ray fluorescence spectrometry (XRF). In the present invention, by using a scanning X-ray fluorescence spectrometer (Rigaku ZSX Primus IV, manufactured by Rigaku Corp.), the atom abundance (% by mass) of the antivirus agent contained in the glaze layer 20 can be obtained under the following measurement conditions and analysis conditions.

### <Measurement Conditions>

Tube voltage: 60 kV
Tube current: 50 mA
Measurement depth: several tens of μm (about 0 to 50 μm)
Measurement area: I) 20 mm
<Analysis Conditions>
La detection line: La L_{α}(alpha) line, 2θ=82.88
Dispersive crystal: LiF (200)
Detector: SC

In the scanning X-ray fluorescence spectrometer, the measurement limit is in the depth region of about 50 μm in the direction from the outermost surface (0 μm) of the glaze layer 20 to the pottery substrate (in the direction as illustrated by the arrow in FIG. 1). Accordingly, the scanning X-ray fluorescence spectrometer quantifies the antivirus agent by the content (% by mass) of the antivirus agent in the region ranging from the outermost surface of the glaze layer 20 to a location with the depth of about 50 μm.

Measurement of the atom abundance (% by mass) of the antivirus agent with the X-ray fluorescence spectrometry (XRF) has a merit in that the content of the antivirus agent in the region ranging from the outermost surface (0 μm) of the glaze layer 20 to a location with the depth of about 50 μm in the direction to the pottery substrate, namely, in the proximity of the surface of the glaze layer 20, can be accurately measured.

Namely, the content of the antivirus agent in terms of the oxide of the antivirus agent as described above represents the content rate (percentage) of the antivirus agent in the entire glaze layer 20. On the other hand, the content of the antivirus agent measured by the X-ray fluorescence spectrometry (XRF) pinpointedly and accurately represents the content rate of the antivirus agent in the proximity of the surface of the glaze layer 20.

In addition, the content of the specific lanthanoid measured by the X-ray fluorescence spectrometry (XRF) is useful to accurately grasp the amounts of various ingredients such as oxides, chlorides, etc. of the specific lanthanoids as the raw material of the antivirus agent to be added, on the basis of the stoichiometry.

In the present invention, it is preferable that the antivirus agent has a melting point of higher than 800° C. to 1300° C. When the antivirus agent has the melting point as described above, it is easier for the antivirus agent to be present in the state of the spinodal phase separation at least on the surface of the glaze layer 20.

### Other Glaze Materials

The glaze layer 20 contains, together with the antivirus agent, materials that are usually used in the glaze, including SiO₂, Al₂O₃, a divalent metal oxide, a monovalent metal oxide, etc.

According to a preferred embodiment of the present invention, the rate of SiO₂ to the glass component is in the range of 52 to 76% by weight; the rate of Al₂O₃ to the glass component is in the range of 6 to 14% by weight; the rate of the divalent metal oxide to the glass component is in the range of 11.4 to 27.6% by weight; and the rate of the monovalent metal oxide to the glass component is in the range of 1.5 to 6.5% by weight.

The glaze layer 20 contains, as main ingredients, SiO₂, Al₂O₃, and the divalent metal oxide and the monovalent metal oxide; and may additionally contains Fe₂O₃, TiO₂, V₂O₅, etc. Examples of the divalent metal oxide include alkali earth metal oxides such as CaO, MgO and the like, as well as ZnO and CuO. Examples of the monovalent metal oxide include Na₂O, K₂O, Li₂O and the like.

In the present invention, a preferable composition of the glaze materials other than the antivirus agent is, for example, shown in Table 1 below.

TABLE 1

| Glaze materials | Content (% by weight) |
|---|---|
| SiO₂ | 52 to 76 |
| Al₂O₃ | 6 to 14 |
| Fe₂O₃ | 0.1 to 0.4 |
| MgO | 0.4 to 2.6 |
| CaO | 8 to 17 |
| ZnO | 3 to 8 |
| K₂O | 1 to 4 |
| Na₂O | 0.5 to 2.5 |

### Surface Properties

In the glaze layer 20 of the sanitary ware 1 according to the present invention, the antivirus agent is present in the state of the spinodal phase separation at least on the surface of the glaze layer 20. Therefore, not only the antivirus property described above can be expressed, but also the impact on the surface properties of the glaze layer can be suppressed; thus, the below-described surface properties, which are suitable for the sanitary ware, can be realized.

### Average Roughness (Ra)

In the present invention, the surface roughness (Ra) of the glaze layer 20 is preferably less than 0.07 μm. The surface roughness (Ra) of less than 0.07 μm allows pollutions such as a urinary stone, a mold, a yellow stain, and others to be difficultly attached to the sanitary ware; and thus, even if the pollutions are attached to the sanitary ware, they can be readily removed therefrom by a weak water current. As a result, the surface of the sanitary ware can be kept in a clean state for a long period of time without frequent washing operations.

According to a preferred embodiment of the present invention, Ra is preferably 0.068 μm or less, more preferably 0.05 μm or less, still more preferably 0.04 μm or less. Thereby, the property which allows pollutions to be difficultly attached to and to be easily removed from the sanitary ware can be more improved.

In the present invention, the term “surface roughness (Ra)” means the center line average roughness (μm) which is defined by JIS-60601 (1994) and is measured by a stylus type surface roughness measuring instrument (JIS-60651).

### DOI Value

In the present invention, the DOI value of the surface of the glaze layer 20 measured by a wave scan DOI measuring instrument is preferably 80 or more. In the present invention, the term “DOI value” means the DOI value that is measured by the wave scanning DOI measuring instrument, for example, Wave-ScanDIO (orange peel measuring instrument) manufactured by BYK Gardner GmbH (Germany). In the present invention, the DOI value is used as an indicator to show an image clarity of the surface of the glaze layer comprised in the sanitary ware according to the present invention. The term “image clarity” means the degree of sharpness of a reflected image of a thing. This appearance quality is determined based on a phenomenon in which reflection of light varies depending on the surface property of the glaze layer, and can be recognized by a human visual sense.

When the DOI value of the surface of the glaze layer 20 is 80 or more, an observer can have an impression that the surface is excellent in the image clarity; as a result, the sanitary ware can have a high-quality appearance. In addition, a high image clarity allows the pollutions attached to the sanitary ware to be conspicuous, thereby enabling the observer to promptly find out attachment of the pollutions including virus. Accordingly, the high image clarity can prevent the observer from leaving the pollutions attached to the sanitary ware. In the present invention, the antivirus agent is present in the state of the spinodal phase separation on the surface of the glaze layer 20. The surface of the glaze layer thus exhibits white color due to light scattering in the interface of the two phases. Accordingly, the surface of the glaze layer 20 having an excellent image clarity can be realized. According to a preferred embodiment of the present invention, the DOI value of the surface of the glaze layer 20 is 85 or more.

In the wave scan DOI measuring instrument described above, a point laser light source moves on the surface of the glaze layer, thereby the surface of the glaze layer is scanned. The instrument measures a bright/dark of a reflected light point by point at a predetermined interval to detect, like human eyes, the optical profile of the surface of the glaze layer. Then, spectral analysis of the resulting optical profile is conducted through a frequency filter to analyze the structure of the surface of the glaze layer. In the microwave scanning by this instrument, a laser beam is irradiated at an angle tilted by 60° from a line perpendicular to the surface of the glaze layer; then, a detector measures a reflected light at the same angle opposite to the perpendicular line. The characteristic spectrum of the instrument is as follows:
du: Wavelength of 0.1 mm or less,
Wa: Wavelength of 0.1 to 0.3 mm,
Wb: Wavelength of 0.3 to 1 mm,
Wc: Wavelength of 1 to 3 mm,
Wd: Wavelength of 3 to 10 mm,
We: Wavelength of 10 to 30 mm,
Sw: Wavelength of 0.3 to 1.2 mm,
Lw: Wavelength of 1.2 to 12 mm,
DOI: Wave length of 0.3 mm or less.

Here, DOI is the parameter composed of du, Wa, and Wb, and is represented by the formula: DOI=f (du, Wa, Wb).

### Color Difference: ΔE* Value

In the present invention, in the glaze layer 20, the color difference (ΔE* value) of the surface thereof is preferably 1.20 or less. When the ΔE* value of the surface of the glaze layer 20 is 1.20 or less, the sanitary ware excellent in lightfastness can be obtained. The ΔE* value is obtained by a weathering test is conducted using a sunshine carbon arc typed weatherometer (S-300, manufactured by Suga Test Instruments Co., Ltd.) based on the sunshine carbon arc typed method described in chapter 9, verse 8 of JIS K5400 (1990). The test is carried out for 8 hours. Before and after the test, L*, a*, and b* of the surface of the glaze layer are measured by the SCE method to obtain the color difference ΔE* (ΔE*=[(ΔL*)²+(Δa*)²+(Δb*)²]^{1/2}). As a color difference meter, a colorimeter (CR-400, manufactured by Konica Minolta, Inc.) may be used.

The color difference (ΔE* value) of the surface of the glaze layer 20 is preferably 0.8 or less, more preferably 0.7 or less.

### Film Thickness

In the present invention, the film thickness of the glaze layer 20 is preferably in the range of 50 μm to 1200 μm, more preferably in the range of 100 μm to 800 μm, still more preferably in the range of 150 μm to 400 μm. When the glaze layer 20 has the film thickness as described above, the surface properties described above can be realized.

### Production Method

The sanitary ware according to the present invention can be preferably produced by the method described below.

First, the pottery substrate 10 is provided. The pottery substrate 10 may be one of those obtained as appropriate by molding a slurry for a sanitary ware substrate that is prepared from heretofore known raw materials such as silica sand, feldspar, clay and others.

A glaze slurry for forming the glaze layer 20, namely, a glaze slurry containing an antivirus agent compound as a starting material of the antivirus agent, and glaze materials other than the agent is prepared. The composition of the glaze materials other than the antivirus agent is, for example, the one shown in Table 1 above.

The antivirus agent compound is preferably an oxide of the antivirus agent or the like having a boiling point of 1,000° C. or higher, more preferably 1,300° C. or higher, and having a melting point of 1,000° C. or higher. The antivirus agent compound is still more preferably a water-insoluble compound having a melting point of 1,000° C. or higher.

The glaze slurry for forming the glaze layer 20 can be prepared, for example, by the methods as described below.

### EMBODIMENT 1

The glaze materials with the composition described in Table 1, water, and a dispersing medium (for example, alumina balls) are put into a pottery pot; then, they are crushed, for example, by a ball mill, to obtain a glaze slurry precursor. Next, an antivirus agent compound is added to the resulting glaze slurry precursor; then, they are mixed and crushed to obtain the glaze slurry for forming the glaze layer 20.

### EMBODIMENT 2

The glaze materials with the composition described in Table 1 are melted at a given temperature, and then is subject to cooling to obtain a frit raw material. Next, an antivirus agent compound is added to the frit raw material; then, to the resulting mixture are further added water, a dispersing medium, and optionally other raw material(s) (for example, China stone and ZnO); then, the resulting mixture is put in a pottery pot and crushed, for example, by a ball mill, to obtain a glaze slurry for forming the glaze layer 20 Note that, in a preferred embodiment of this embodiment, the content of the antivirus agent compound in the glaze slurry is, when the total amount of the frit raw material and other raw material(s) described above is 100% by weight, the weight ratio of the antivirus agent compound.

According to a preferred embodiment of the present invention, in the embodiments 1 and 2, it is preferable that the average particle diameter of the antivirus agent compound after crushed is almost the same as the average particle diameter of the glaze material after crushed. For example, it is preferable that the average particle diameters of the antivirus agent compound and of the glaze material are almost the same, such as 10 μm or less, more preferably in the range of 6 to 7 μm. Here, the average particle diameter means the so-called 50% particle diameter in the particle size distribution data measured with a laser diffraction method. The expression that the average diameters are “almost the same” means that the ratio of the average particle diameter of the antivirus agent compound to the average particle diameter of the glaze material (former/latter) is in the range of 0.9 to 1.1.

By harmonizing the average particle diameters of the antivirus agent compound with the average particle diameters of the glaze material, not only the antivirus agent is allowed to be present in the state of the spinodal phase separation at least on the surface of the glaze layer 20, but also the surface properties described above (Ra, DOI value, and ΔE* value) can be realized.

Next, the glaze slurry for forming the glaze layer 20 is applied onto the surface of the pottery substrate 10. Examples of the appropriately selectable application method include general methods such as a spray coating, a dip coating and the like, but are not particularly limited thereto.

Next, the pottery substrate 10 to which the glaze slurry for forming the glaze layer 20 has been applied is fired. Namely, the pottery substrate 10 and the glaze slurry are integrally fired. The firing temperature is preferably a temperature at which the sanitary pottery substrate is sintered and the glaze is softened, and is more preferably a temperature which meets with the requirements above and is lower than the melting point of the antivirus agent. The firing temperature like this is preferably in the range of 1,000° C. or more to 1,300° C. or less, more preferably in the range of 1,150° C. or more to 1,250° C. or less. The integral firing is done preferably only once. When the integral firing is done only once, it has been confirmed by the inventors of the present invention through experiments that crystallization of the antivirus agent can be suppressed. Specifically, when the firing is done more than once, it has been confirmed that crystals are precipitated from the amorphous layer of the glaze layer. For example, it has been confirmed that when the second firing is done at the temperature lower than the temperature of the first firing, crystals are precipitated.

Next, the resulting sintered body is cooled. There is no particular restriction in the cooling condition. Cooling method may be a natural cooling. Cooling temperature and cooling time may be controlled as appropriate.

When the pottery substrate 10 and the glaze slurry, that is prepared in a state that the average particle diameter of the antivirus agent compound is almost the same as the average particle diameter of other glaze material(s), are integrally fired once at the temperature lower than the melting point of the antivirus agent and then the fired product is cooled, while suppressed crystallization of the antivirus agent, the antivirus agent can be preferably vitrified, the antivirus agent can be more preferably present in a state of a glass liquid phase (a glass melt), the glass melt can be still more preferably phase-separated, and the glass melt can be most preferably present in a state of the spinodal phase separation. As a result, the glaze layer 20 whose surface is abundant in the region in which the antivirus agent is present in the state of the spinodal phase separation can be obtained.

### EXAMPLES

The present invention is specifically described on the basis of Examples below, but the present invention is not at all limited to the Examples.

### Preparation of Pottery Substrate

By using the pottery substrate slurry prepared with the raw materials including silica sand, feldspar, clay, etc., a plate-like test piece having the size of 70 mm×150 mm was prepared.

### Preparation of Glaze Slurry for Forming Base Glaze Layer

2 kg of the glaze materials having the composition described in Table 2 below, 1 kg of water, and 4 kg of alumina balls were put into a pottery pot with a volume of 6 L; then, the resulting mixture was crushed by a ball mill such that the particle size distribution of the crushed products measured by the laser diffraction typed particle size distribution meter can be characterized in that the abundance ratio of the particles having the diameter of 10 μm or less is 65%, and the 50% particle diameter of the particles is about 6.5 μm to obtain the glaze slurry for forming the base glaze layer.

TABLE 2

| Glaze materials | Content (% by weight) |
|---|---|
| SiO₂ | 55 to 80 |
| Al₂O₃ | 5 to 13 |
| Fe₂O₃ | 0.1 to 0.4 |
| MgO | 0.8 to 3.0 |
| CaO | 8 to 17 |
| ZnO | 3 to 8 |
| K₂O | 1 to 4 |
| Na₂O | 0.5 to 2.5 |
| Zircon | 0.1 to15 |
| Pigment | 1 to 20 |

### Preparation of Glaze Slurry for Forming Antivirus Glaze Layer

2 kg of the glaze materials having the composition described in Table 3 below, 1 kg of water, and 4 kg of alumina balls were put into a pottery pot with a volume of 6 L; then, the resulting mixture was crushed by a ball mill such that the particle size distribution of the crushed products measured by the laser diffraction typed particle size distribution meter can be characterized in that the abundance ratio of the particles having the diameter of 10 μm or less is 65%, and the 50% particle diameter (D50) of the particles is about 6.5 μm to obtain a glaze slurry precursor. To the glaze slurry precursor thus obtained was added 5% by weight of the oxides of the metal elements described in Table 4 (namely, 5% by weight of the oxides of the metal elements relative to the total content (100% by weight) of the glaze materials above); then, the resulting mixture was mixed and crushed by a ball mill such that the particle size distribution of the crushed products can be characterized in that the abundance ratio of the particles having the diameter of 10 μm or less is 65%, and the 50% particle diameter (D50) of the particles is 6.5 μm to obtain antivirus glaze slurries for the sanitary wares of Examples 1 to 10 and Comparative Example 1.

TABLE 3

| Glaze materials | Content (% by weight) |
|---|---|
| SiO₂ | 52 to 76 |
| Al₂O₃ | 6 to 14 |
| Fe₂O₃ | 0.1 to 0.4 |
| MgO | 0.4 to 2.6 |
| CaO | 8 to 17 |
| ZnO | 3 to 8 |
| K₂O | 1 to 4 |
| Na₂O | 0.5 to 2.5 |

### Production of Sanitary Ware

Each of the resulting antivirus glaze slurries was applied onto the pottery substrate test piece by a spray coating method. Next, each of the products thus obtained was integrally fired once in a furnace at 1200° C., and then was cooled to obtain the sanitary wares of Examples 1 to 10 and Comparative Example 1.

### Evaluation

The following evaluations were conducted for the sanitary wares of Examples 1 to 10 and Comparative Example 1.

### Content of Antivirus Agent

The content of the rare earth element in terms of the oxide of the rare earth element in the glaze layers of the sanitary wares of Examples 1 to 10 and Comparative Example 1 was calculated as follows. For example, for the sanitary ware of Example 1, the content of the rare earth element was calculated to be approximately 4.8%, as the percentage of lanthanum oxide (5% by weight) to the total (105% by weight) of 100% by weight of the glaze materials described in Table 3 and the lanthanum oxide (5% by weight), namely, by the formula represented by [5% by weight/(100% by weight+5% by weight)×100]. The same was applied to each of the sanitary wares of Examples 2 to 10 and Comparative Example 1.

### Antivirus Property

The antivirus activity value against the bacteriophage Qβ was obtained by the following test method based on ISO 21702.

A virus solution (0.4 mL) was dropped onto each of the sanitary wares of Examples 1 to 10 and Comparative Example 1, and onto a sanitary ware comprising the glaze layer not containing an antivirus agent, as a control, and then, the sanitary wares were covered with a film.
The respective sanitary wares were statically left at 25° C. for 24 hours. Next, the viruses on the respective sanitary wares were washed off and recovered; then, the virus infectivity titer was measured.
By the following formula, the antivirus activity value was calculated.

R=Uₜ-Aₜ

R: Antivirus activity value

Uₜ: Common logarithm of the virus infectivity titer (PFU/cm²) of the control sanitary ware, measured after the control has been statically left for 24 hours.

Aₜ: Common logarithm of the virus infectivity titer (PFU/cm²) of the respective sanitary wares of Examples 1 to 10 and Comparative Example 1, measured after the sanitary wares have been statically left for 24 hours.

The antivirus activity values of the sanitary wares of Examples 1 to 10 and Comparative Example 1 were those shown in Table 4.

### Average Roughness (Ra)

By using a stylus type surface roughness measuring instrument (WS-60651), the center line average roughness (μm) that is defined by WS-60601 (1994) was obtained. The results were shown in Table 4.

### DOI Value

The DOI value was measured by using the wave scanning DOI measuring instrument, Wave-ScanDIO (orange peel measuring instrument) manufactured by BYK Gardner GmbH (Germany). The results were shown in Table 4.

### Confirmation of the Presence State of Antivirus Agent in Glaze Layer

### <XRD Measurement>

The measurement was carried out with XRD instrument, “X′Pert PRO”, manufactured by PANalytical Inc., under the following conditions.

### <XRD Measurement Conditions>

Measurement range: 3° to 60°
Scanning rate: 4°/min
Applied voltage: 45 V, applied current: 40 mA

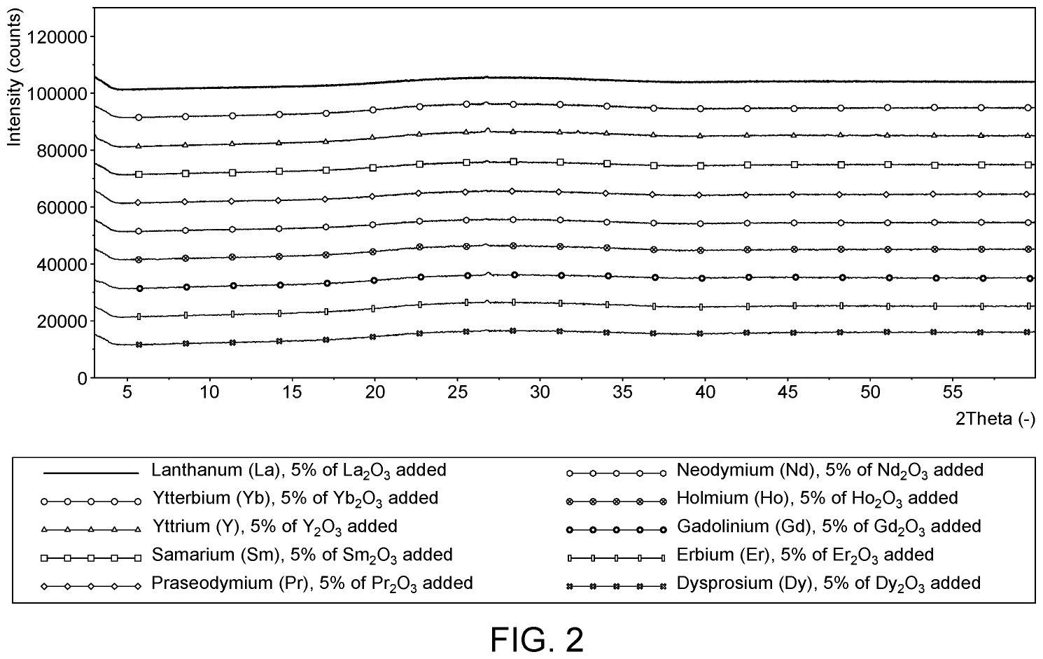

As can be seen in FIG. 2, any peak was not found in the XRD measurement of the surface of the antivirus glaze layer containing the respective metal elements. Accordingly, it was confirmed that the respective metal elements exist in an amorphous (non-crystalline) state or in a vitrified state on the surface of the antivirus glaze layer.

### SEM Observation and TEM Observation

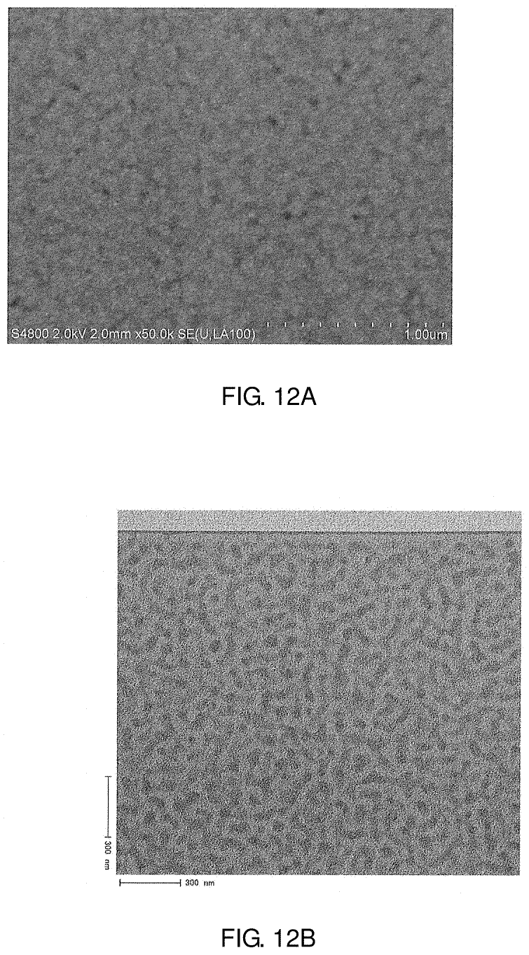

The presence state of the respective metal elements in the proximity of the surface of the antivirus glaze layer was confirmed by the SEM observation and the TEM observation. The SEM observation was carried out by using the instrument S4800 (manufactured by Hitachi High-Tech Corp.) under the conditions: magnification of 50,000× and the applied voltage of 2.0 kV, and the applied current of 20 mA (2.0 mm×50.0 k, SE (U, LA100)). The TEM observation was carried out by using the instrument H-9500 (manufactured by Hitachi High-Tech Corp.) under the conditions: magnification of 100,000×and the applied voltage of 200 kV (MST-20-113310 ID No. 4448c). The SEM images and the TEM image are shown in FIGS. 3A to 12A and FIGS. 3B to 12B. In the SEM images, the white portion indicates the presence of the metal element, and the black portion indicates Si—O structure. In the TEM image (FIG. 12B), the black portion indicates the presence of the metal element, and the white portion indicates Si—O structure. In the cross-sectional SEM image, the white portion that appears to be a boundary line indicates that the metal element is abundantly present. In the TEM image (FIG. 12B), the black portion that appears to be a boundary line indicates that yttrium is abundantly present. In the cross-sectional SEM images and in the cross-sectional TEM image, the image region above the portion that appears to be a boundary line is an air region, so said image region is not a region to be observed.

From the images shown in FIGS. 3 to 12, it was confirmed that the respective metal elements are abundantly present in the proximity of and on the surface of the antivirus glaze layer, and that the respective metal elements are in the state of the spinodal phase separation, and that the amount of the respective metal elements that are in the state of the spinodal phase separation is abundant.

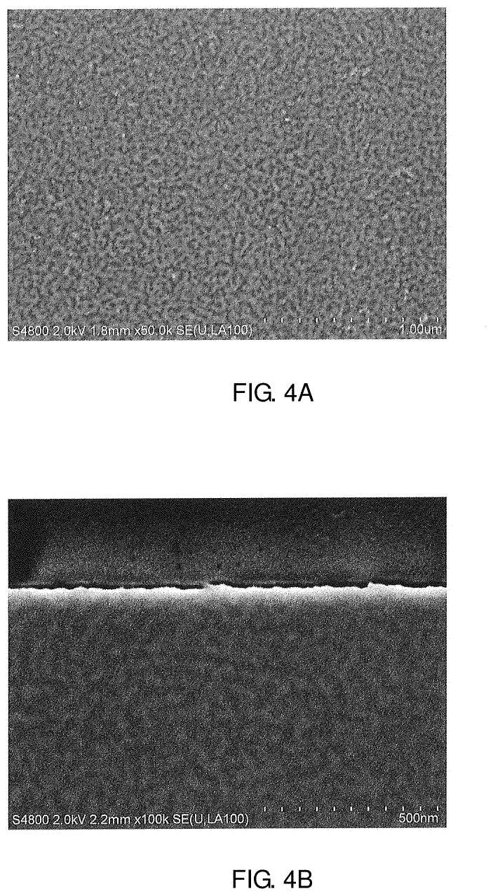

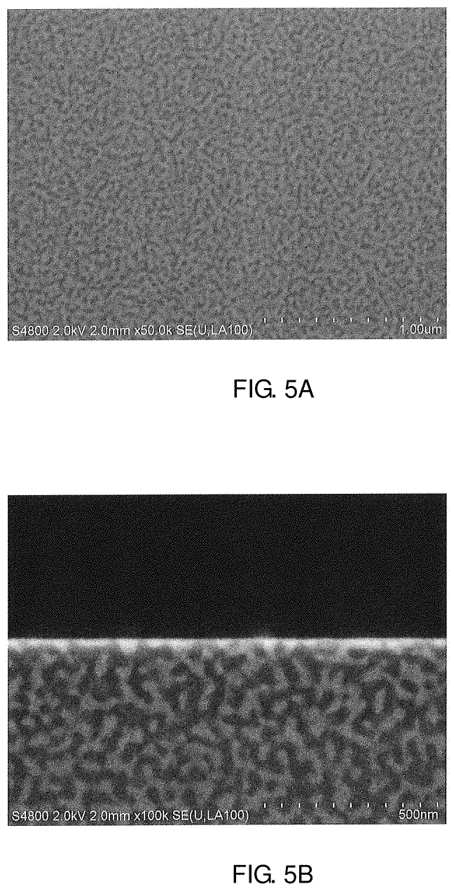

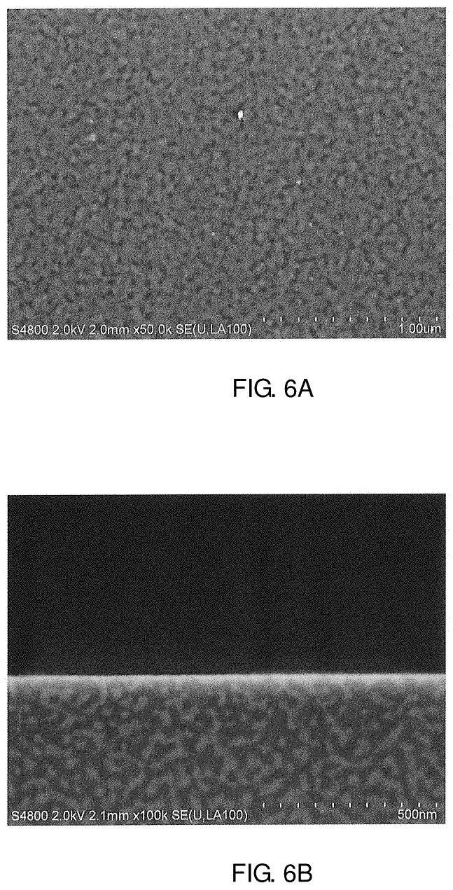

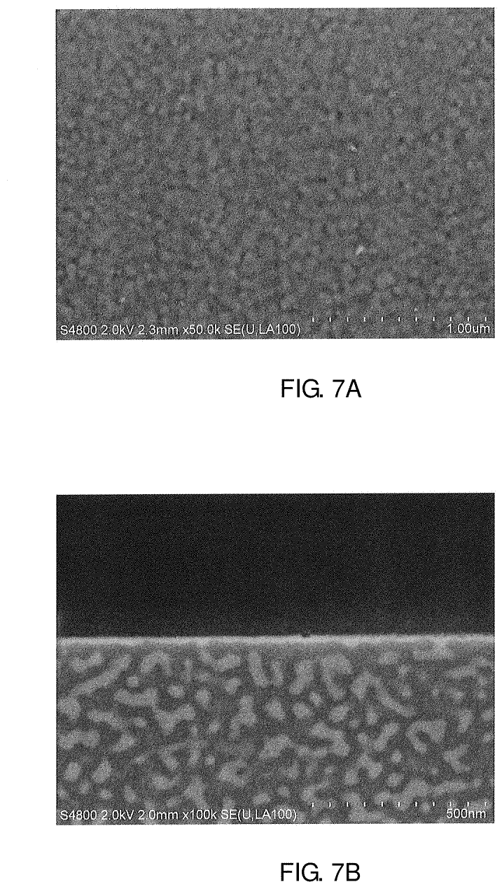

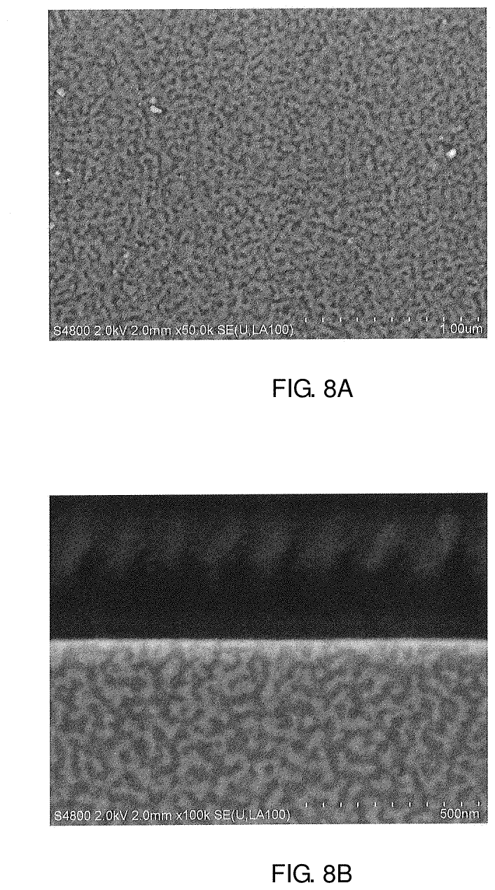

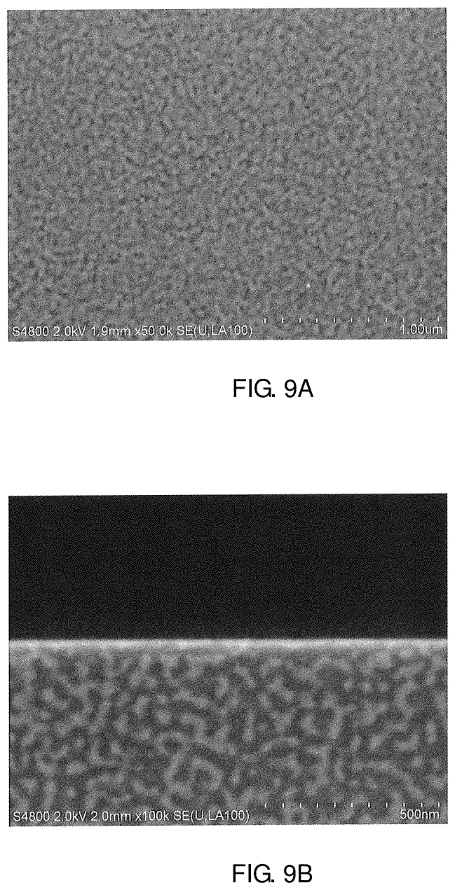

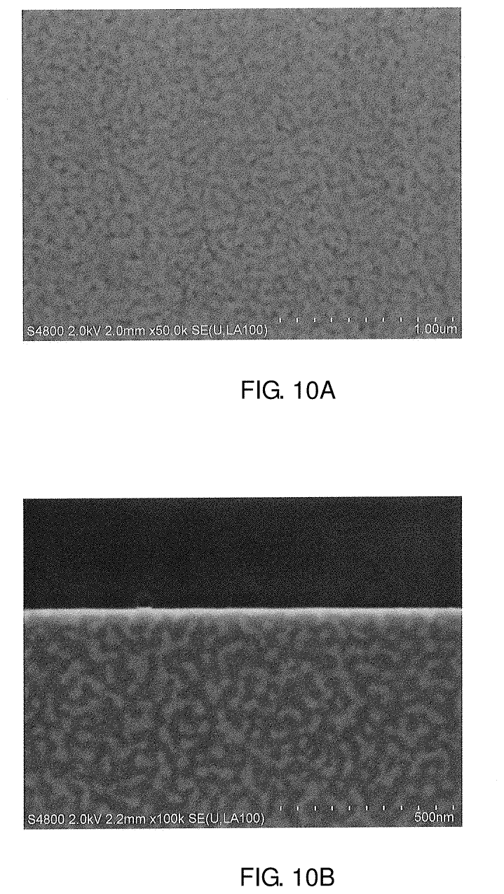

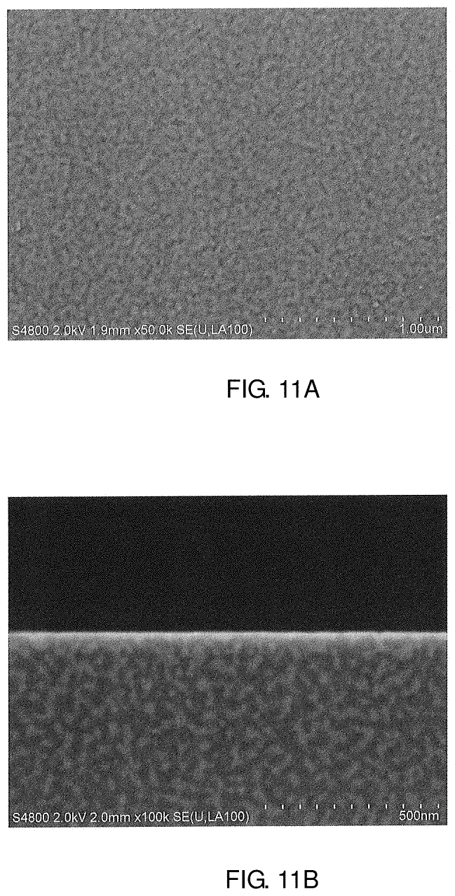

TABLE 4

| | Metal | Antivirus | Surface | | | Surface | Cross-sectional |
|---|---|---|---|---|---|---|---|
| Sanitary ware | element | activity value | roughness Ra | DOI | ΔE | SEM image | SEM/TEM image |
| Example 1 | La | 1.5 | 0.0615 | 86.1 | Z | FIG. 3A | FIG. 3B SEM |
| Example 2 | Nd | 3.1 | 0.0470 | 82.5 | | FIG. 4A | FIG. 4B SEM |
| Example 3 | Pr | 2.6 | 0.0457 | 82.0 | | FIG. 5A | FIG. 5B SEM |
| Example 4 | Sm | 3.9 | 0.0416 | 81.9 | | FIG. 6A | FIG. 6B SEM |
| Example 5 | Gd | 3.8 | 0.0419 | 80.6 | | FIG. 7A | FIG. 7B SEM |
| Example 6 | Dy | 3.4 | 0.0425 | 82.5 | | FIG. 8A | FIG. 8B SEM |
| Example 7 | Ho | 3.8 | 0.0350 | 85.8 | | FIG. 9A | FIG. 9B SEM |
| Example 8 | Er | 4.0 | 0.0456 | 83.3 | | FIG. 10A | FIG. 10B SEM |
| Example 9 | Yb | 5.5 | 0.0404 | 83.9 | | FIG. 11A | FIG. 11B SEM |
| Example 10 | Y | 6.0 | 0.0563 | 83.3 | | FIG. 12A | FIG. 12B TEM |
| Comparative | Ce | 0.5 | 0.4765 | 0.0 | | | |
| Example 1 | | | | | | | |

From the results shown in Table 4, it was confirmed that the sanitary ware of Comparative Example 1 containing Ce had a low antivirus activity value, and also had poor surface properties (Ra value and DOI value); whereas the sanitary wares of Examples 1 to 10 each containing the particular rare earth element had a high antivirus activity value, and also had good surface properties (Ra value and DOI value). Namely, it was confirmed that the sanitary ware according to the present invention had not only a practical antivirus property but also a property which greatly allows pollutions to be difficultly attached to, and to be easily removed from the sanitary ware. Furthermore, it was confirmed that these meritorious properties are expressed synergically.

### Confirmation of the Presence (Distribution) State of Antivirus Agent in Glaze Layer Based on Content of Antivirus Agent

The sanitary wares of the cases 1 to 15 were prepared in the same manner as the sanitary ware of Example 1 except that content of lanthanum is variedly changed.

The amount (% by weight) of lanthanum in terms of lanthanum oxide (La₂O₃) contained in the glaze layer of the sanitary wares of the cases 1 to 15 as well as the atom abundance (% by mass) contained in the same measured by XRF are respectively shown in Table 5.

The content (% by weight) of lanthanum in terms of lanthanum oxide (La₂O₃) in the respective sanitary wares shown in Table 5 was calculated as follows. For example, for the sanitary ware of the case 4, the content of lanthanum was calculated to be approximately 4.8%, as the percentage of lanthanum oxide (5% by weight) to the total (105% by weight) of 100% by weight of the glaze materials described in Table 3 and the lanthanum oxide (5% by weight), namely, by the formula represented by [5% by weight/(100% by weight+5% by weight)×100]. The same was applied to each of the sanitary wares of the rest cases 1 to 3 and 5 to 15. The sanitary ware of the case 4 is the same as that of Example 1.

When the content (% by weight) of lanthanum in terms of lanthanum oxide (La₂O₃) in each sanitary ware is compared with the content of lanthanum (% by mass) in each sanitary ware measured by XRF, it was confirmed that the latter was higher. This verifies that the content of lanthanum in the proximity of the surface of the antivirus glaze layer is higher than that in the entire antivirus glaze layer. Namely, this verifies that lanthanum is concentrated in the proximity of the surface of the antivirus glaze layer.

Therefore, the present invention allows the antivirus agent to be present in the concentrated state in the proximity of the surface of the glaze layer, so that an excellent antivirus property can be expressed. In addition, the present invention allows the antivirus agent to be concentrated in the proximity of the surface of the glaze layer, even if the amount of the antivirus agent is small, so that the sanitary ware according to the present invention can effectively express an excellent antivirus property. At the same time, as the small amount of the antivirus agent does not influence on Si—O structure in the glaze layer, the sanitary ware with excellent surface properties maintained over times can be realized.

### Lightfastness (Discoloration Suppressibility)

The lightfastness (discoloration suppressibility) of the sanitary wares of the cases 1 to 15 was evaluated.

Specifically, the weathering test was conducted using a sunshine carbon arc typed weatherometer (manufactured by Atlas Electrical Devices Co., USA) based on the sunshine carbon arc typed method described in JIS K5400-9-8. The test was carried out for 8 hours. Before and after the test, L*, a*, and b* of the surface of the glaze layer were measured by the SCE method to obtain the color difference ΔE* (ΔE*=[(ΔL*)²+(Δa*)²+(Δb*)²]^{1/2}).

As a color difference meter, a colorimeter (CR-400, manufactured by Konica Minolta, Inc.) was used. The results are shown in Table 5.

TABLE 5

| | Content of Lanthanum | | | | | | | |
|---|---|---|---|---|---|---|---|---|
| | Amount of La in | Atom abundancy | | | | | | |
| | terms of La2O3 | measured by XRF | Antivirus | | | | Surface | Cross-sectional |
| Sanitary ware | (% by weight) | (% by mass) | activity value | Ra | DOI | ΔE | SEM image | SEM image |
| Case 1 | 1.0% | 1.1% | 0.6 | 0.0341 | 87.2 | 0.86 | | |
| Case 2 | 2.2% | 4.2% | 1 | 0.0484 | 80.7 | 0.78 | | |
| Case 3 | 3.4% | 6.4% | 2.3 | 0.0452 | 80.4 | 0.58 | | |
| Case 4 | 4.8% | 8.3% | 1.5 | 0.0358 | 85.5 | 0.74 | FIG. 3A | FIG. 3B |
| Case 5 | 5.7% | 10.6% | 3.3 | 0.0308 | 87.7 | 1.13 | | |
| Case 6 | 6.5% | 12.4% | 3.3 | 0.0360 | 86.4 | 0.99 | | |
| Case 7 | 7.4% | 13.9% | 3.8 | 0.0315 | 86.9 | 0.67 | | |
| Case 8 | 8.3% | 15.1% | 3.8 | 0.0306 | 85.8 | 0.73 | | |
| Case 9 | 9.1% | 17.7% | 5.1 | 0.0375 | 83.6 | 0.68 | | |
| Case 10 | 10.0% | 15.1% | | 0.0804 | 74.0 | 0.6 | | |
| Case 11 | 10.7% | 16.9% | | 0.0886 | 74.4 | 0.3 | | |
| Case 12 | 11.5% | 18.9% | 5.7 | 0.1008 | Measurement | 0.74 | | |
| | | | | | NG | | | |
| Case 13 | 14.2% | 21.2% | 5.3 | 0.0729 | Measurement | 1.79 | | |
| | | | | | NG | | | |
| Case 14 | 16.7% | 23.4% | 3.6 | 0.1320 | Measurement | 0.82 | | |
| | | | | | NG | | | |
| Case 15 | 20.0% | 25.2% | 5.3 | 0.1106 | Measurement | 1.53 | | |
| | | | | | NG | | | |

### Relationship Among Content of Antivirus Agent, Amount of Antivirus Agent Eluted, and Antivirus Activity Value

The relationship among the content of the antivirus agent, the amount of the antivirus agent eluted, and the antivirus activity value in the sanitary wares of the cases 1 to 15 was confirmed.

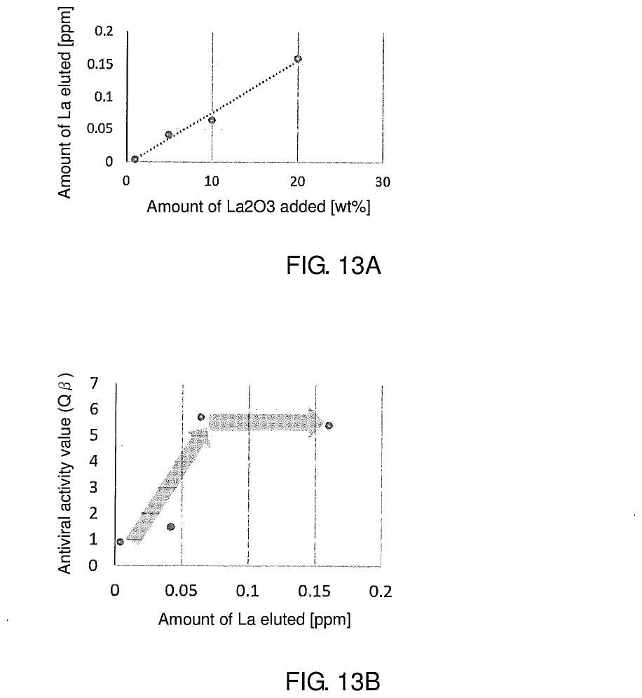

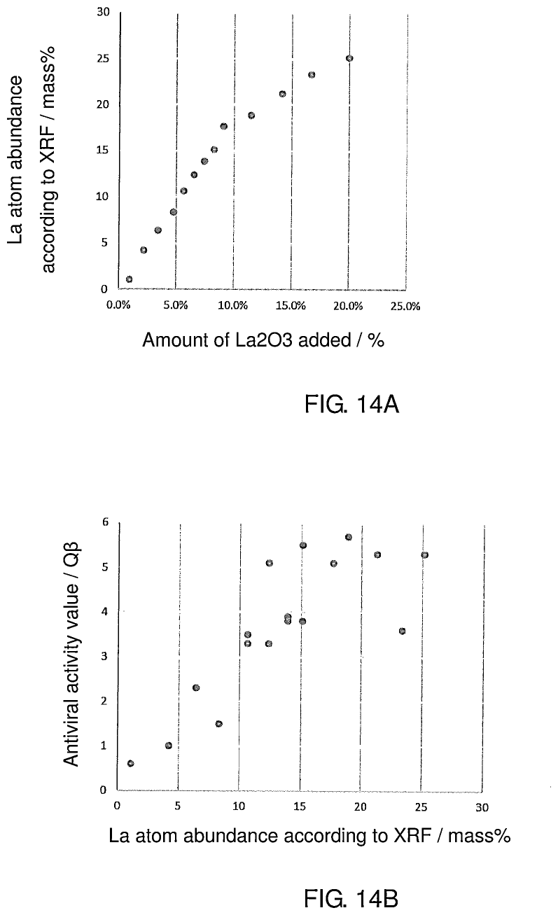

In FIG. 13A, the relationship between the amount (% by weight) of lanthanum in terms of lanthanum oxide (La₂O₃) and the amount (ppm) of lanthanum eluted to the surface of the glaze layer is shown. In FIG. 13B, the relationship between the amount of lanthanum eluted and the antivirus activity value is shown. In FIG. 14A, the relationship between the amount (% by weight) of lanthanum in terms of lanthanum oxide (La₂O₃) and the atom abundance (% by mass) of lanthanum measured by XRF is shown. In FIG. 14B, the relationship between the atom abundance (% by mass) of lanthanum measured by XRF and the antivirus activity value is shown.

From FIG. 13 and FIG. 14, it was confirmed that there is a proportional relationship between the amount (% by weight) of lanthanum in terms of lanthanum oxide (La₂O₃) and the atom abundance (% by mass) of lanthanum measured by XRF, and that there is a proportional relationship between the content of lanthanum and the amount of lanthanum eluted to the surface of the glaze layer, and that there is a proportional relationship between the amount of lanthanum eluted and the antivirus activity value.

Note that, as for the sanitary ware of Example 10 (the sanitary ware comprising the glaze layer containing 4.8% by weight of yttrium), the amount of yttrium eluted was 0.051 ppm.

### Confirmation of Relationship Among Firing Condition, Amount of Spinodal Phase Separation, and Antivirus Activity Value

An antivirus glaze slurry prepared by the preparation method described above in which the amount of lanthanum oxide added was 10% by weight was applied onto the pottery substrate test piece described above by spray coating method. Then, the resulting product was fired in a furnace under the conditions 1 to 3 described below to prepare three sanitary wares A to C.

Sanitary ware A: Firing condition 1 (firing temperature: 1,200° C., firing time in total: 10 hours)

Sanitary ware B: Firing condition 2 (firing temperature: 1,200° C., firing time in total: 15 hours)

Sanitary ware C: Firing condition 3 (firing temperature: 1,200° C., firing time in total: 20 hours)

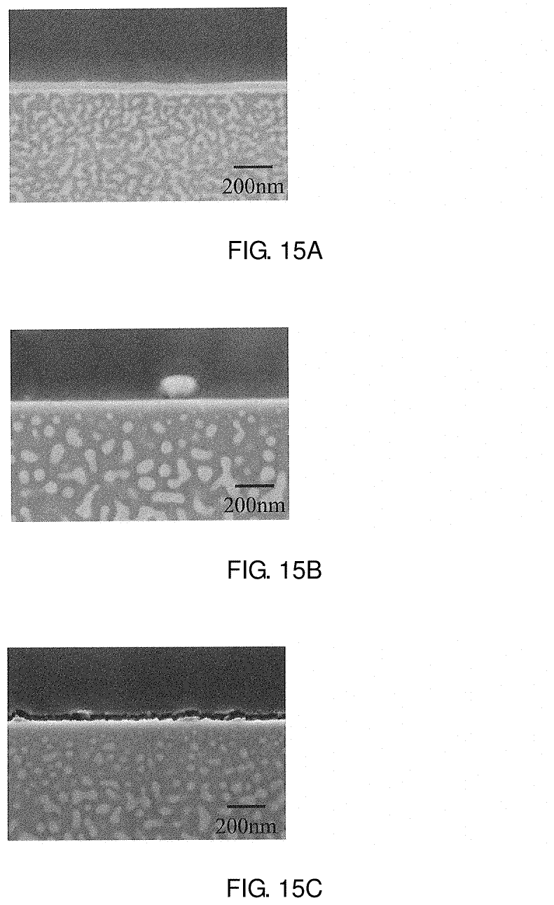

The antivirus activity values of the sanitary wares A to C are shown in Table 6 below. The presence state of lanthanum in the proximity of the surface of the antivirus glaze layer in each of the sanitary wares A to C is shown in FIGS. 15A to 15C.

TABLE 6

| | | | Antivirus | Cross- |
|---|---|---|---|---|
| Sanitary | Metal | | activity | sectional |
| ware | element | Firing condition | value | SEM image |
| A | La | 1 (firing temperature: | 5.9 | FIG. 15A |
| | | 1200° C., firing | | |
| | | time: 10 hours) | | |
| B | La | 2 (firing temperature: | 3.9 | FIG. 15B |
| | | 1200° C., firing | | |
| | | time: 15 hours) | | |
| C | La | 3 (firing temperature: | 1.6 | FIG. 15C |
| | | 1200° C., firing | | |
| | | time: 20 hours) | | |

From Table 6 and FIGS. 15A to 15C, it was confirmed that, among the sanitary wares A to C prepared in common under the same conditions, i.e., the amount of lanthanum oxide added and the firing temperature, the sanitary ware A prepared under the shortest firing time exhibits an excellent antivirus property, and that the lanthanum is in the state of the spinodal phase separation in the proximity of the surface of the glaze layer 20, and that the separate phase region is abundant therein. On the other hand, it was confirmed that, in the sanitary ware B prepared under longer firing time, the binodal phase separation and the spinodal phase separation are mixedly present, so that the sanitary ware B has a lower antivirus property than the sanitary ware A. Furthermore, it was confirmed that, in the sanitary ware C prepared under the longest firing time has a lower antivirus property than the sanitary wares A and B. Note that a person skilled in the art can adopt a variety of methods other than the methods described above in which the particle diameter and the firing time are controlled, as methods for allowing particular rare earth elements such as lanthanum to be present in the state of the spinodal phase separation in the proximity of the surface of the glaze layer 20.

What is claimed is:

1. A sanitary ware comprising a pottery substrate and a glaze layer formed on a surface of the pottery substrate, wherein
the glaze layer contains a metal element as an antivirus agent, and
the metal element is present in a state of a spinodal phase separation at least on a surface of the glaze layer.

2. The sanitary ware according to claim 1, wherein the antivirus agent is present in the state of the spinodal phase separation in a region ranging from the surface of the glaze layer to a location with the depth of 10 nm inside the glaze layer in a direction from the surface of the glaze layer to the pottery substrate.

3. The sanitary ware according to claim 1, wherein the antivirus agent is a rare earth element.

4. The sanitary ware according to claim 1, wherein a melting point of the antivirus agent is 800° C. to 1300° C. or more.

5. The sanitary ware according to claim 1, wherein a base glaze layer is further provided between the pottery substrate and the glaze layer.

6. A method for manufacturing the sanitary ware according to claim 1, wherein the method comprises the steps of
providing a pottery substrate,
preparing a glaze slurry comprising a metal element that is an antivirus agent and a graze material other than the antivirus agent,
applying the glaze slurry onto a surface of the pottery substrate, and
firing the pottery substrate to the surface of which the glaze slurry is applied to form a glaze layer.

7. The method according to claim 6, wherein the firing is carried out at a temperature lower than a melting point of the antivirus agent.

8. The method according to claim 6, wherein an average particle diameter of the antivirus agent is almost the same as that of the glaze material.

9. The method according to claim 6, wherein the method further comprises the steps of forming a base glaze layer on a surface of the pottery substrate, and applying the glaze slurry onto a surface of the base glaze layer.

10. The sanitary ware according to claim 1, capable of inactivating a virus attached to the surface of the glaze layer.

11. A method for expressing an antivirus property on a surface of a glaze layer containing a metal element as an antivirus agent, by allowing the metal element to be present in a state of a spinodal phase separation at least on the surface of the glaze layer, the glaze layer being formed on a surface of a pottery substrate to establish a sanitary ware.
